(19) United States
(12) Patent Application Publication
(10) Pub. No.: US 2026/0311214 A1
(43) Pub. Date: Oct. 8, 2026

(54) METHOD AND SYSTEM FOR DIGITAL MARKETING ADVERTISEMENT BASED ON EYE AND GAZE ANALYSIS BY ARTIFICIAL INTELLIGENCE AS FOR USER OF SMART DEVICES EQUIPPED WITH CAMERA

(71) Applicant: SK Planet Co., Ltd., Seongnam-si (KR)

(72) Inventor: Kichon KANG, Seoul (KR)

(21) Appl. No.: 19/681,095

(22) Filed: May 19, 2026

Related U.S. Application Data
(63) Continuation of application No. PCT/KR2024/005382, filed on Apr. 22, 2024.

(30) Foreign Application Priority Data
Nov. 21, 2023 (KR) 10-2023-0161856
Nov. 22, 2023 (KR) 10-2023-0163014

(51) Int. Cl. G06Q 30/0251; G06Q 30/0241

(52) U.S. Cl. CPC G06Q 30/0255; G06Q 30/0277

(57) ABSTRACT

A computer-implemented method for transmitting Internet advertisements from an ad server to a user terminal equipped with a camera, the method including: receiving an Internet advertisement from an advertiser's terminal; transmitting the advertisement to the user terminal for display on an advertising display area of the user terminal's screen; collecting image or video data including the user's face via the camera for processing by an AI analysis tool on the user terminal or ad server; extracting gaze information from the collected data to determine whether the user's gaze overlaps with the advertisement display area; and modifying the display mode of the advertisement if the user's gaze is directed toward the advertisement display area. The method further maximizes advertising effect by dynamically adjusting user benefit levels within the advertisement in real time based on objectively determined user interest derived from the gaze information.

### CROSS REFERENCE TO RELATED APPLICATIONS

This is a bypass continuation of International PCT Application No. PCT/KR2024/005382, filed on Apr. 22, 2024, which claims priority to Korean Patent Applications No. 10-2023-0161856, filed on Nov. 21, 2023, and No. 10-2023-0163014, filed on Nov. 22, 2023, which are hereby incorporated by reference in their entirety.

### BACKGROUND

### 1. Field of the Invention

The present invention is an invention for a digital marketing advertising method, computer recording medium and system based on AI analysis of the eyes and gaze of the user of a smart device equipped with a camera. The present invention aims to maximize the effect of digital advertising or Internet advertising by analyzing the user's gaze of a smart device equipped with a camera (hereinafter referred to as “AI”) and using the analysis results for digital marketing in real time.

### 2. Description of the Related Art

Thanks to advances in wired and wireless networks and computer technology, the digital advertising market is expected to reach US$700 trillion globally in 2023 alone. There may be various criteria for defining the concept and different types of digital advertising. In general, Internet digital advertising using Internet technology is operated in three main ways: CPI (Cost Per Impression), CPC (Cost Per Click), and CPA (Cost Per Action).

CPI is a method in which an Internet portal site collects an advertising fee of 0.5 KRW (hereinafter, “won”) to 5 won for each time an Internet advertisement is exposed to users. For example, the CPI method is usually adopted when enough end users and clients of a website have already been secured, such as a large Internet portal site. Advertisers sign an advertising contract valid until the number of impressions reach a certain threshold, or they are guaranteed that their advertisements will be displayed, for example, on a certain large portal site for a predetermined period of time regardless of the number of impressions. For the latter, this kind of fixed-term flat-rate advertising method is also known as CPT (Cost Per Time). For example, there are cases where the advertiser agrees to pay a certain advertising fee for each 1,000 impressions to the large portal site company. Of course, if the Internet portal site is using another Internet advertising agency for its advertising business, the fee for the advertising agency may be added for the advertiser, but there are many cases where large Internet portal sites directly handles Internet advertising plans to advertisers without third-party advertising agencies.

In the case of the CPC method, the advertiser does not pay for advertising fees based on impressions alone, but pays the advertising fees after calculating the number of times the Internet advertisement is actually clicked. In the case of keyword advertising that usually adopts this CPC method, for example, 100 won to thousands of won may be collected per click. Different amount of CPC fees may be based on a bidding price system in conjunction with specific keywords. If the advertiser agrees to pay higher bidding price for a specific keyword, the advertiser's advertisement will be displayed in more easily accessible way when an Internet user makes internet searches with that specific keyword.

However, it has chronic problems such as, for example, searches or clicks made by machines (e.g., search bots), meaningless and continuous clicks by users, or intentional fraudulent clicks to induce competitors to waste advertising costs. In this case, it may lead to a waste of advertising costs from the advertiser's point of view. Of course, various methods are being developed to technically solve the problem of fraudulent clicks.

CPA may be the most advantageous method for advertisers. It is a structure that settles advertising fees only when an Internet user accesses the advertiser's website through an Internet advertisement and completes some event that the advertiser wanted for marketing such as the user's membership registration for the advertiser's goods. Such “event” may be a user's action to apply for a credit card, purchase a merchandise, or participate in a specific marketing campaign. For example, advertisers only need to sign partnership marketing contracts with multiple website operators and pay advertising fees only when some designated advertising event occurs. However, if partnership marketing is not successful, there may be cases where some of the planned advertising budget turns out to be redundant. There may be another cases where the consumers later decided to cancel their actions (such as purchasing) so that the advertiser who already paid for the CPA advertising fee cannot actually enjoy the advertising performance.

CPI, CPC, CPA, or a combination of them seem to have a big difference in terms of the criteria for collecting advertising costs, but all of these advertisements can be seen as measuring advertising costs based on whether the advertiser's Internet advertisements have received attention from users. However, CPI is based on the premise that the advertisement may have attracted the users' attention to some extent just by exposing the advertisement on the website visited by the users. CPC is based on the premise that if the act of clicking is followed, it can be an indicator that the advertisement has succeeded in attracting users' attention. CPA is an Internet advertising technique that admits that it has attracted users' attention only when there is an event such as the user's purchase.

However, in the case of various Internet advertising techniques that have been proposed so far, there is no clear answer to how to increase the user's interest on the advertisement. In fact, what to use as a basis for determining whether the advertisement attracted users' interest is somewhat unclear. As another example of conventional marketing strategy, a targeted advertising will be described.

The targeted advertising refers to an advertising strategy carried out by an advertiser by relating trait information of potential consumers to the product or service to be advertised or marketed. For example, if a consumer Z who accesses a search engine site X visits an advertiser's specific website Y, the operator of the search engine site X may know Z's website visit history to Y and IP (Internet Protocol) address of the consumer Z. Thus, the operator of the search engine site X can improve advertising efficiency by targeting the advertisements requested by advertiser Y to people who have similar trait or website surfing habit as the consumer Z. If the consumer Z has a history of visiting advertiser Y's website for any reason, targeted advertising is becoming a very important tool, especially in online advertising, because providing consumer Z with Y's advertising materials can be expected to be effective because, for example, the potential consumer Z is more likely to return to Y's website and purchase products after finding the advertisement. In the above case, it can be seen that X, the operator of the search engine site, acts as an advertising agency, and Y becomes an advertiser who pays an advertising fee to X with an expectation that X may efficiently provide targeted advertising to potential consumers who are more likely to have interest in Y's advertisements.

Of course, targeted advertising is not limited to search engines, but can be used as a targeted advertising platform. Wherever a large number of potential buyers access and use, such as IP TV, smart phone applications, apps, and social media platforms, such accessibility may be helpful for the targeted advertising. IP TV can know what consumers have watched. App developers can know what kind of smartphone users use their apps. Social media platforms can know the activities of users at the platform. Thus, IP TV, apps, social media, etc. can be used as advertising platforms when they place advertisements for the platform users. In short, according to the targeted advertising strategy, effective advertising may be expected as long as the advertisers can choose a proper group of people for their advertisements and successfully draw those people's attention to the advertisers' product or service that may be relevant to the trait or habit of the potential users.

Despite the above efforts, the current targeted advertising system has several problems, which can be roughly summarized into two main problems: problems on the side of companies that post advertisements (i.e., advertisers) and problems on the side of Internet users and consumers. First of all, from the advertiser's point of view, a low conversion rate (Conversion Rate; CVR) has always been a problem. The conversion rate refers to the percentage of how many Internet users have seen a specific advertisement and then converted to actions such as clicking or purchasing. The conversion rate is often around 2 to 10%. If the conversion rate is higher than 10%, it can be assumed that the advertiser spent a lot of advertising cost at very popular websites with a high CPC bidding cost. However, on the other hand, from the consumer's point of view, most of the internet pages may be full of uninterested digital advertising which can be treated as a kind of internet pollution to the users. Regardless of specific advertising strategy, so many pop-ups, banners, or partnership marketing may be perceived by consumers as a cyber pollution, which would not be very different from their spam email experiences.

As mentioned above, the key to Internet advertising is whether it can properly evaluate the user's interest in the advertisement with a reasonable yardstick. In summary, (a) CPI advertising can be said to be a method in which the advertisement is considered to have gained a certain amount of user attention just by user's being exposed on the Internet, and (b) in CPC advertising, it is assumed that the user's clicking behavior must be confirmed to gain the attention of Internet users. (c) In the case of CPA advertising, the criterion for judging user interest is whether or not the advertisement performance or event according to a certain criteria, such as actual purchase behavior or participation in a marketing campaign, through Internet advertising. (d) Targeted advertising is an advertising strategy that aims to increase conversion rates by advertising to a group of Internet users who are likely to show interest in the content to be advertised, rather than by advertising to unspecified group of people.

Another aspect that needs to be considered from the advertiser's point of view is profit. For example, another U.S. survey in 2016 found that if a seller with a 30% margin at the full price offers a 10% discount, the actual profit margin will be reduced by more than 50%. In other words, even if the difference between 1~2% discount benefits may seem insignificant to the buyer's point of view, from the seller's point of view, it is promotional marketing that can have a big impact on company profits in some cases. If sales performance is poor despite promotional marketing, advertisers and sellers will inevitably go through negative financial impacts due to increased advertising costs and reduced profits.

In short, it is necessary to have an appropriate yardstick that can reasonably judge whether customers are interested in advertising, and furthermore, it is necessary to understand how much marketing cost may be spent to successfully gain the consumers' interest and simultaneously maximize the advertiser's profits.

### SUMMARY OF THE INVENTION

As mentioned earlier, advertisements that do not attract the attention of Internet users can be recognized as cyber pollution, while advertisements that attract the attention of Internet users can not only be useful Internet information for users, but also contribute to improving advertising efficiency by leading to sales from the advertiser's point of view. However, it is questionable whether conventional Internet advertising techniques properly measure users' interests.

Conventional CPI advertising techniques assume that Internet advertisements are displayed on websites that attract users' attention, but Internet users do not know whether such exposed advertisements are useful information or just one of many indifferent information in cyberspace.

CPC ads, represented by keyword search ads, may show excellent conversion rates for some advertisers who rank high in search for specific keywords, but it may be difficult for the majority of lower-ranked advertisers to expect advertising effectiveness compared to advertising costs. For example, if a search engine searches for a specific keyword, the user has to view multiple Internet pages or wait for the advertisement to be displayed for a long time before the advertisement is displayed to the user.

CPA advertising is called affiliate marketing, for example, by installing a separate advertising space on a website or even a game app, and requiring users to complete actions such as participating in events set by the advertiser in exchange for benefits such as game money. In this case, it is difficult to confirm whether users are interested in game money, etc., which is given for achieving affiliate marketing conditions, or whether they are interested in the advertisement itself and applied for affiliate marketing.

In the case of online targeted advertising, if the information used for customer targeting is more than necessary, consumers may feel resentful of targeted advertising rather than interested in the advertisement and feel that their privacy has been violated.

In addition, none of the CPIs, CPCs, CPAs, or targeted advertising provide clear answers to how to optimize advertisers' profits. This means that advertisers are not provided with information on how much promotion they need to provide to Internet users to achieve successful digital marketing. In the end, the advertiser will become the seller, and issues such as margin may be an issue for advertisers, not an advertising agency or portal site that can take care of it.

The present invention is recognized as a task to solve the above problems, but the first key point is that none of the various Internet advertising techniques mentioned above lacks an attempt to more precisely determine whether users are interested in Internet advertisements and to elicit greater interest from users who have shown interest. If it is possible to make only users who are interested in Internet advertisements more interested (thereby improving advertising efficiency) by accurately grasping the interests of Internet users and dynamically adjusting the display of advertisements accordingly, it can be said that the present invention originates from the idea that all or at least some of the problems presented above can be solved.

The second key technical problem recognized by the present invention is to find a solution to what extent the benefits in the advertisement should be provided to maximize corporate profits while inducing users' purchasing behavior to increase the conversion rate. Accordingly, the present invention proposes a method to improve the profit of advertisers by tracking the user's reaction to digital advertisements that have already attracted the attention of Internet users, but Internet users have not yet switched to any purchase behavior, in a little more detail.

In addition, the technical problem that the present invention seeks to solve is not limited to Internet advertising generated by a traditional PC (personal computer). Rather, the present invention focuses on advertising to users of IT (Information Technology) or ICT (Information Communications Technology) devices, which can be collectively referred to as “smart devices” such as laptops, smartphones, and smart pads equipped with cameras. Considering the high computing speed, abundant storage capacity, and network environment that supports these smart devices, it is believed that the problems in advertising techniques mentioned above can be solved to some extent technically.

The present invention is designed to solve all or part of the above problems, and in order to solve the first technical problem, the present invention proposes a technology for accurately grasping the interest of Internet users and dynamically adjusting the advertising display or exposure mode accordingly.

In other words, according to the first aspect of the present invention, a method of transmitting Internet advertisements from an ad server to a user terminal equipped with a camera for advertising comprises the first step of receiving the Internet advertisement from the advertiser's terminal; the second step of transmitting the received Internet advertisement to the user terminal so that the Internet advertisement is posted and displayed on the advertising display area of the viewing screen of the user terminal; the third step of collecting image or video data including the user's face through the user terminal and the camera so that it can be processed by an AI analysis tool installed on the user terminal or the advertising server; the fourth step, extracting information related to the user's gaze from the collected image or video data by the AI analysis tool, and determining whether the user's gaze overlaps with the advertisement display area on which the Internet advertisement is posted based on the user's gaze information; and if the user's gaze is determined to be directed towards the advertisement display area, an Internet advertising method using AI gaze analysis is proposed, which is characterized by including a fifth step to change the exposure method of the Internet advertisement in the user's terminal.

In the case of the advertising method according to the second aspect of the present invention, the modified exposure method, or advertisement display mode, is characterized by comprising a method of increasing the size of the part where the Internet advertisement is posted and exposed, or a method of changing the position on the viewing screen on which the Internet advertisement is posted and displayed.

For the advertising method according to the third aspect of the present invention, the AI analysis tool includes a complex computer vision AI analysis tool that can process images, videos, or all of them, and the criteria for determining whether the advertising display area and the user's gaze overlap in the fourth step are: (a) whether the measured duration of fixation exceeds a predetermined threshold; (b) the existence of the advertising display area on the Scanpath, and (c) the existence of the display area within the Convex Hull created by the Scanpath, which may consist of at least one or more combinations.

For the advertising method according to the fourth aspect of the present invention, the AI analysis tool may comprise a step in which the AI analysis tool generates a user gaze map with respect to the user's gaze information on the viewing screen, and on that basis, determines whether the advertisement display area and the user's gaze overlap.

The fifth aspect of the present invention relates to a system that embodies an advertising method according to the first aspect described above. The fifth aspect of the present invention is an ad server system that transmits Internet advertisements to a user terminal equipped with a camera for advertising, receives the Internet advertisement from the advertiser's terminal, and transmits the received Internet advertisement to the user terminal, so that the Internet advertisement is displayed and displayed on the advertising display area of the user terminal's viewing screen; and through the user terminal and the camera, including a database that collects, classifies, and stores image or video data including the user's face so that it can be processed by an AI analysis tool installed on the main server, extracts information related to the user's gaze from the collected image or video data by the AI analysis tool, and determines whether the user's gaze overlaps with the advertisement display area where the Internet advertisement is posted based on the user's gaze information, when the user's gaze is determined to be directed towards the advertisement display area, it is characterized by the main server changing the display method of the Internet advertisement in the user's terminal.

Next, the sixth aspect of the present invention focuses on the second technical challenge of the aforementioned present invention, which includes the first stage in which the ad server receives Internet advertisements from the advertiser's terminal; the second step of transmitting the received Internet advertisement to a user terminal equipped with a camera and publishing and displaying the Internet advertisement in a predetermined advertising exposure area among the display screen of the user terminal; the third step of collecting image or video data including the user's face through the user terminal and the camera so that it can be processed by an AI analysis tool installed on the user terminal or the advertising server; the fourth step of extracting information related to the user's gaze from the collected image or video data by the AI analysis tool, and determining whether the Internet advertisements posted and exposed are attracting the user's attention based on the user's gaze information according to the prescribed judgment criteria; and if it is determined that the posted and exposed Internet advertisements are attracting the attention of users, a digital advertising method using AI gaze analysis is proposed, which is characterized by including the fifth step of raising the level of benefits contained in the Internet advertisement in real time.

The seventh aspect of the present invention relates to a system that embodies the sixth aspect of the above-mentioned aspect, wherein the system comprises a main server that receives an Internet advertisement from an advertiser's terminal, transmits the received Internet advertisement to a user terminal equipped with a camera, and publishes and displays the Internet advertisement on a predetermined advertisement exposure area on the display screen of the user terminal; and a database that collects and stores image or video data including the user's face through the user terminal and the camera, and the main server executes an AI analysis tool installed on the main server by interacting with the database, and the AI analysis tool extracts information related to the user's gaze from the collected image or video data, and determines whether the Internet advertisements posted and exposed are attracting the user's attention based on the user's gaze information according to the prescribed judgment criteria. If it is determined that the Internet advertisement posted and exposed is attracting the user's attention, a digital advertising system using AI gaze analysis is proposed, which is characterized by performing an action to raise the level of benefits contained in the Internet advertisement in real time.

First of all, according to the first to fifth aspects of the present invention mentioned above, the present invention has a common core of accurately grasping the interest of Internet users and dynamically adjusting the advertising display accordingly.

In other words, smart devices such as smartphones are equipped with cameras, and the present invention proposes a technology that interprets the user's gaze on the advertisement as the user's interest in the advertisement by determining which part of the screen of the smartphone the Internet user visiting a website with a smartphone is looking at, and whether the part where the advertisement is exposed. In short, the present invention proposes a rational and technical solution to the analysis of user interest, which is the core of Internet advertising, by incorporating AI technology that tracks eye movement (eye tracking) and grasps the user's gaze (gaze detection) in Internet advertising.

In the present invention, since the user's gaze is identified as the user's interest, it is possible to know whether the user is interested in the advertisement more sophisticated than the conventional CPI advertising method, and thus it is possible to calculate the advertising cost more reasonably.

When comparing the present invention with the CPC method, there is a big difference between the present invention and the CPC method in that it analyzes the user's interest from the stage before the user's click action. In particular, the present invention proposes a method of changing the exposure method of the advertisement by enlarging the Internet advertisement or changing the location when it is determined to be an advertisement of interest to the user, which can be understood as a technical solution to induce the user to convert the behavior such as clicking, in other words, to obtain greater interest from the user.

However, this invention is not an idea to create a separate advertising page for affiliate marketing like CPA advertising. The present invention proposes an advertising technique that is different from conventional affiliate marketing or CPA advertising by introducing a technology in which the advertisement directed by the user's gaze is an advertisement that the user is interested in according to AI analysis. Even if the present invention is compared with targeted advertising, it can be regarded as an AI advertising technology that can be applied to any Internet user using a smart device without the need to collect information on the characteristics of Internet users that match the target to be advertised in advance and select the target advertising target.

In particular, the present invention proposes to use an AI analysis tool called computer vision that can process images, videos, or all of them in analyzing the interests of Internet users. As previously premised, the present invention focuses on Internet advertising aimed at users of smart devices equipped with cameras. In other words, the present invention analyzes which part of the screen that the user is currently viewing by using a camera mounted on a smart device, and by accurately confirming the user's interest through this, technical measures are prepared so that the advertiser can accept that the user's interest measurement method according to the present invention is reasonable. In particular, it proposes a rational method of judging user interest using AI technology, such as the period of fixed focus of the user's gaze, whether the advertisement was displayed on the scanpath of the user's gaze, and whether there were Internet advertisements in the space created by the scanpath.

Furthermore, the present invention dynamically changes the exposure method of Internet advertisements based on the user's gaze analyzed by AI, and uses a gaze map (Gaze Map) for each webpage generated or pre-generated in real time, and can also analyze whether the space on which the advertisement is placed on the screen of a smartphone is the most ideal in light of this gaze map.

If the AI gaze analysis according to the present invention is performed in real time on the ad server, it will be possible to change the display method of the advertisement in real time according to the situation, which is expected to maximize the efficiency of advertising. In particular, if it is confirmed that the user has successfully generated a user click by changing the display method of the existing Internet advertisement to obtain more user attention and attention, and even a user click has occurred, it may be possible to establish an advertising cost policy that satisfies both the advertiser and the advertising agency by storing the successful user click history in real time and feeding it back to the advertiser's terminal.

In short, the first to fifth aspects of the present invention not only improve the efficiency of advertising cost execution from the advertiser's point of view, but also lead to the effect of making the advertisement presented according to the present invention perceived as useful information by the user by filtering out advertisements that do not attract the attention of Internet users and advertisements that attract the attention of Internet users by AI, thereby enabling dynamic advertising exposure that can increase the advertising effect of advertising materials that can be useful information for users.

According to the sixth to seventh aspects of the present invention mentioned below, the present invention proposes a digital advertising method that uses AI eye recognition technology to select digital advertisements that attract the attention of Internet users, and observes which level of promotion is provided in real time to observe which level of promotion is provided by Internet users to actively respond to the advertisements.

The effects of the sixth to seventh aspects of the present invention are as follows: In other words, while watching the benefits of the advertisement that the user is currently staring at increase little by little in real time, the ad server can see how much benefit the user is provided to switch from just staring at the advertisement to making a purchase. This accumulated data is expected to be of great help in determining how much benefit advertisers should provide to elicit a response from potential consumers. In this way, AI eye analysis according to the present invention can be done in real time on the ad server, and in this case, it will be possible to change the benefits offered by the advertisement being displayed in real time and lead to the user's behavior conversion more effectively.

### BRIEF DESCRIPTION OF THE DRAWINGS

The present invention may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a drawing representing an Internet advertising system using the AI gaze analysis according to one embodiment of the present invention.

FIG. 2 is a drawing representing an exemplary configuration of AI software that can be used for AI gaze analysis according to the one embodiment of the present invention.

FIG. 3 is a drawing to illustrate the operation mode of the computer vision AI software according to the one embodiment of the present invention.

FIG. 4 and FIG. 5 are drawings for illustrating the image data and related gaze data analysis information analyzed in real time by computer vision AI software according to one embodiment of the present invention.

FIG. 6 shows an example of analyzing the user's gaze with AI according to one embodiment of the present invention and synthesizing the analyzed result with a specific website in the form of a map with the scanpath (that is, a moving path of the gaze) information according to the saccade (that tis, an instantaneous movement of the eyeball).

FIG. 7 shows an example of a heat map made by analyzing the user's gaze by AI according to one embodiment of the present invention and reflecting the fixation duration of the user's eye and gaze while the focus of the user's eye is fixed.

FIG. 8 shows an example of modifying the display size of the internet advertisement in which a user is currently interested in, after completing the AI analysis of the user's gaze according to one embodiment of the present invention.

FIG. 9 is a drawing showing another example of enhancing the user's interest on the internet advertisement by creating a virtual finger image with a generative AI technology according to one embodiment of the present invention.

FIG. 10 is an illustration showing an example of upgrading the user's benefit offered in the original internet advertisement to some higher level in real time based on the results of AI's gaze analysis according to one embodiment of the present invention.

### DETAILED DESCRIPTION

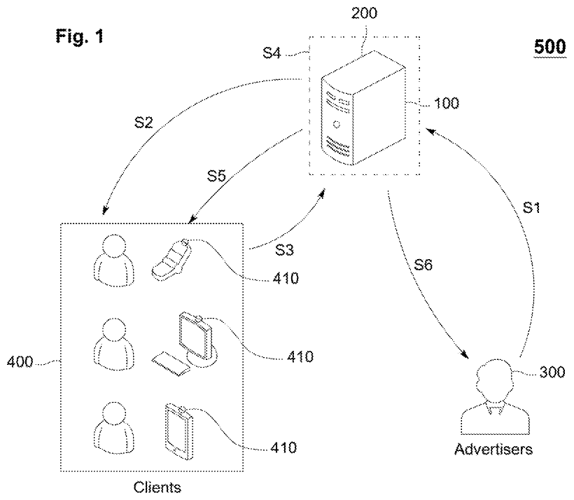

Hereinafter, a preferred embodiment of the present disclosure is described in detail with reference to the accompanying drawings. FIG. 1 to FIG. 4 show various examples of coupons or what can be treated as coupons, for an AI analysis, according to the present invention.

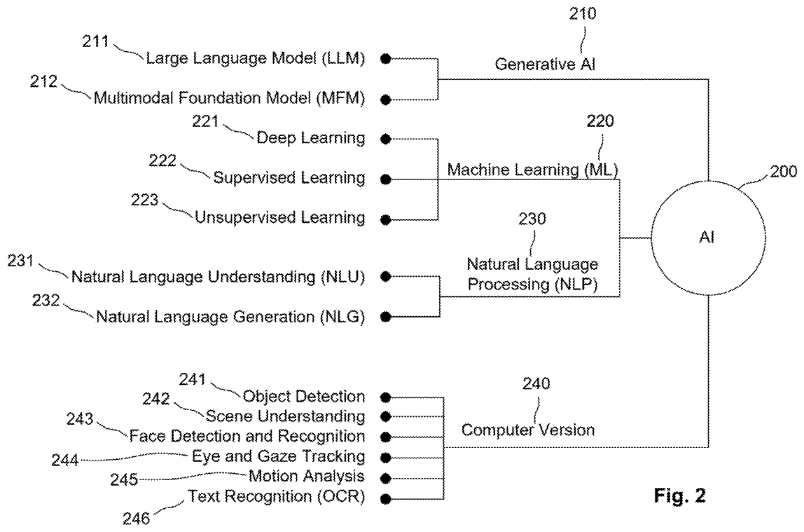

FIG. 1 is a drawing representing an Internet advertising system (500) using the AI gaze analysis according to one embodiment of the present invention. As shown FIG. 1, an Internet advertising system using AI gaze analysis according to one embodiment of the present invention (500, the “AI advertising system”) consists of an AI advertising server and a database (100). As will be described later in FIG. 2, the AI software (200) according to the present invention can may be integrated with the AI ad server and database (100). In order for the AI ad server and database (100) to operate as an advertising agency, it is necessary to interact with the advertiser's terminal (300), and it is also necessary to interact with the client or consumer terminal (400, e.g., the smartphone of Internet user who will come into contact with the advertisement; the client terminal) by means of wired or wireless network.

Meanwhile, here is a brief explanation about the camera (410). In recent years, for example, the cameras (410, including front and rear cameras (not shown)) of smartphones (400) include a wide camera (411), a telephoto camera (412), and an ultra-wide camera (413) capable of high-quality shooting at 12 MP (megapixels). Furthermore, for example, these cameras (411, 412, and 413) are often surrounded by other small devices such as camera flashes (414), LiDAR (Light Detection and Ranging) scanners (not shown), and microphones for canceling noise and background sounds when shooting videos. In the present invention, for convenience, various types of cameras (411, 412, 413) or infrared cameras that can be attached to smart devices may be collectively referred to as “a camera (410)”.

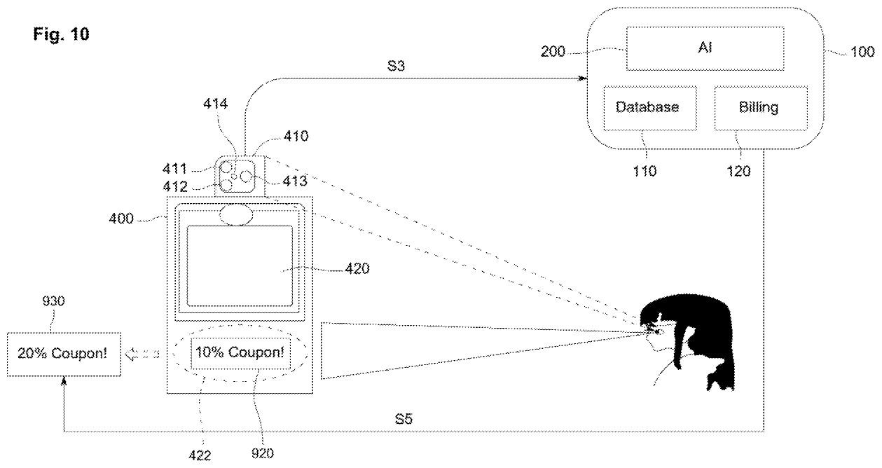

Referring to FIG. 1 again, in step S1, the AI ad server and database (100) receives an online advertisement from the advertiser's terminal (300) based on a predetermined advertising fee contract. The advertisement display method, such as the posting period, posting location, and posting method (e.g., banner type or pop-up type) of Internet advertisements, is usually predetermined in the advertising fee contract. However, it should be noted that the present invention's AI ad server and database (100) may have the right to dynamically control the mode of ad exposure, preferably in real time. In addition, as in the case of FIG. 10 below, the present invention requires that the AI ad server and database 100 be able to gradually and dynamically increase the level of user benefits included the promotion. Thus, it may be necessary to consult with the advertiser 300 in advance so that the AI ad server and database 100 may have the right to change the promotion benefits in real time to apply the key features of the present invention to the online advertising.

For reference, if the AI ad server and database 100 executes the AI software 200 in real time, the AI ad server and database 100 will be equipped with a central processing unit (CPU) and Graphic Processor Unit (Graphic Processor Unit; GPU), FPGA (Field Programmable Gate Arrays), and various accelerator cards to improve computing speed and performance in hardware. Such high-level AI system may be especially desirable for handling complex AI calculations in real time.

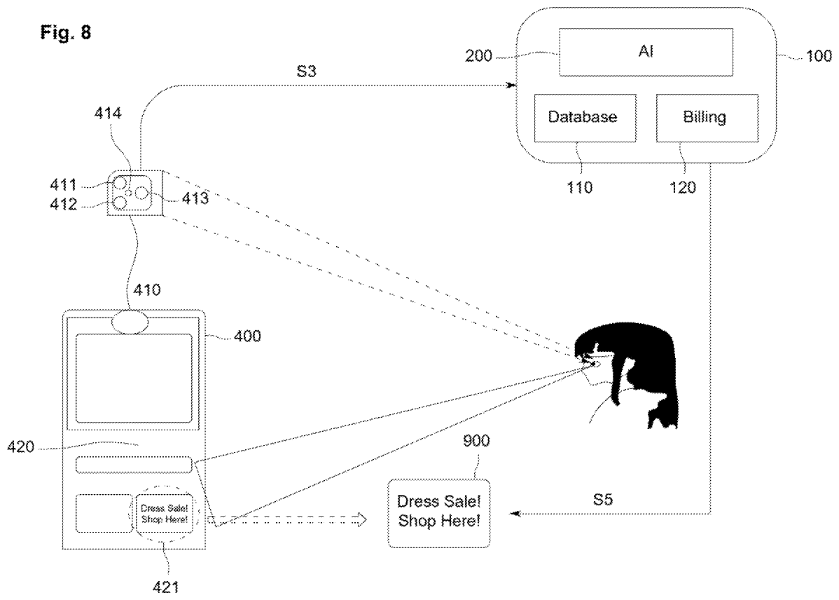

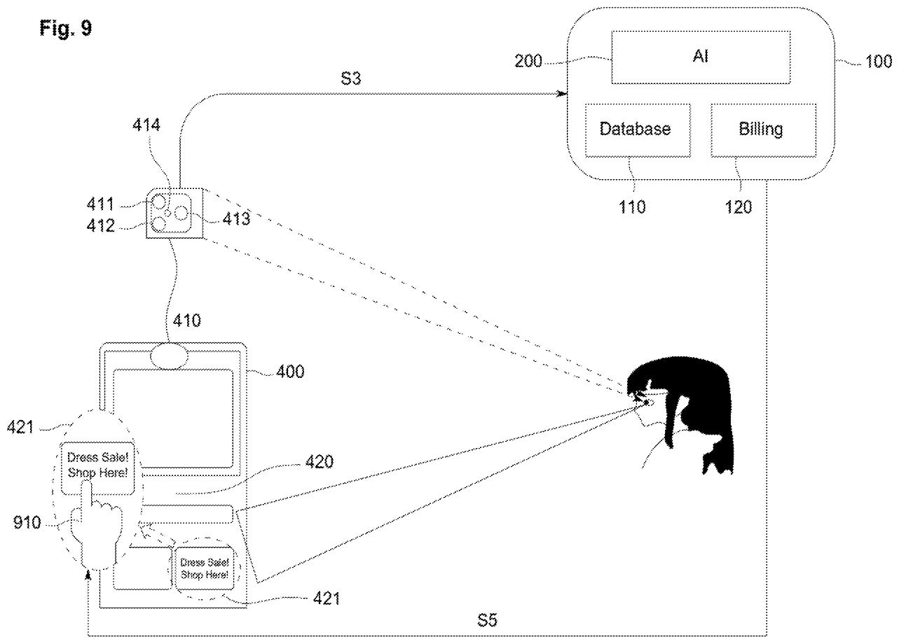

In Step S2, the AI ad server and database (100) sends Internet advertisements to the client terminal (400) based on the advertiser's request (300). Referring to FIGS. 8 and 9, the “Dress Sale! Shop Here! (Clothing sale, shop here!)” Internet advertisements will be placed in a specific advertisement display area (421) on the screen (420) of a smartphone (400). Referring to FIG. 10, the digital banner advertisement (920) called “10% Coupon” sent from step S2 will be placed in another specific advertising area (422) within the screen (420) of the smartphone (400).

In step S3 of FIG. 1, the AI ad server and database (100) receives images or video data taken by the camera (410) of the client terminal (400) in real time. Of course, in order to improve the efficiency of advertising, it is necessary to obtain personal information consent from the client terminal (400) regarding camera shooting and external transmission of the data from the client terminal to the AI ad server and database (100) in advance. It is desirable that the image or video data transmitted by Step S3 be facial data, including at least the user's eyes. Although the AI can filter out images that contain non-facial objects or backgrounds, according to the present invention, as long as an information may be useful for the eye and gaze analysis, such information may not be discarded.

In step S3 of FIG. 1, in addition to the user's facial information, various client data information can be transmitted and collected by the AI ad server and database (100). For example, the AI ad server and database (100) may be a search engine operator, and the client terminal (400) may receive information such as the history of websites accessed and the history of viewing content with the user's consent to provide personal information to the AI ad server and database (100). In this way, by collecting and storing tracking information about the user's usage of the app or web activities (hereinafter referred to as “client tracking information”) that occurs on the client terminal (400), the AI ad server and database (100) can aggregate more accurate advertising performance and analyze whether Internet advertisements are clicked on in conjunction with certain actions of the user. The client tracking information collected and stored in this way may also be the subject of analysis by the AI software (200), which will be described later in FIG. 2.

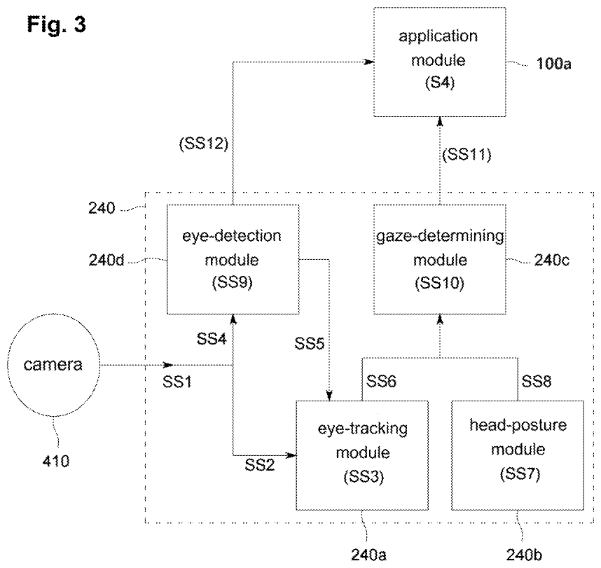

In Step S4, AI gaze analysis is performed, which will be explained in more detail in FIGS. 2 and 3. Although the physical subject of the analysis is shown in FIG. 1 as the AI ad server and database (100), the AI software (200) can be installed on another external server (not shown) that can be linked with the AI ad server and database (100) and run Step S4, or it is possible to run AI gaze analysis with the user's consent installed on the client terminal (400) and only transmits the analysis results to the AI ad server and database (100).

Next, in Step S5, the AI ad server and database (100) determines and executes the advertisement display method that can attract more attention for the client terminal (400) users based on the results of the user's gaze analysis conducted in Step S4 with the consent of the advertiser.

Here, FIG. 8 and FIG. 9 will be referred. As a result of the user's gaze analysis by AI software (200), it may be determined that the user pays attention to the aforementioned “Dress Sale! Shop Here!” in the advertisement display area (421) where the published Internet advertisement (900) is located. Now, the AI ad server and database (100) may take several measurements to draw more attention from the user who already looked at the internet advertisement.

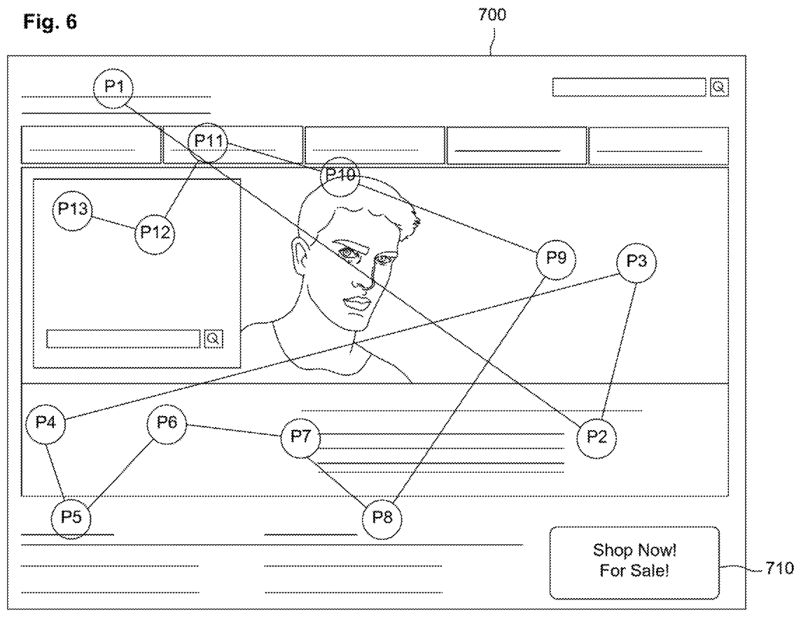

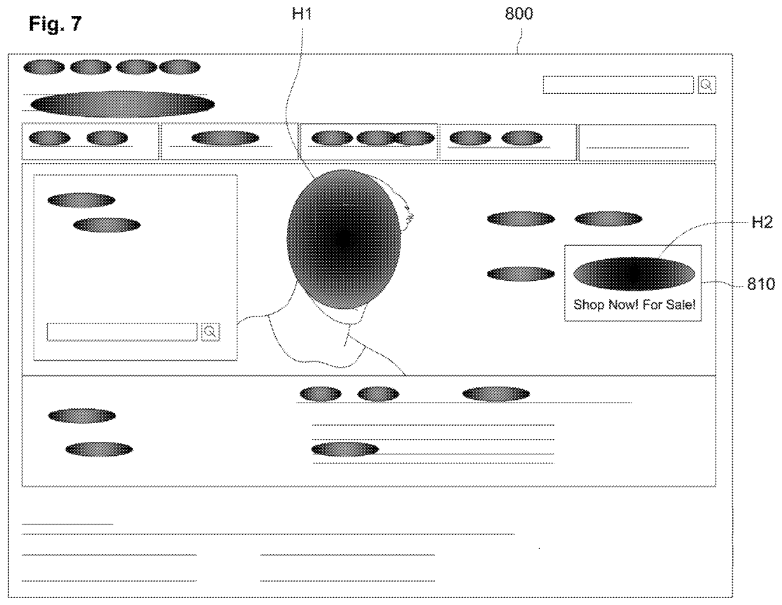

First, in order to obtain greater attention from the user, the AI ad server and database (100) may replace the original advertisement (421) by the newly-created enlarged advertisement (900) as in FIG. 8. Such newly-created enlarged advertisement (900) may be placed on the exact spot with the original advertisement (421) or may be placed on some other advertisement display area (not shown) based on, for example, a gaze map in FIGS. 6 and 7 to increase the likelihood of the user's clicking on the advertisement.

In addition, the AI ad server and database (100) may generate a virtual hand image (910) by a generative AI technology to increase the likelihood of the user's clicking on the advertisement as shown in FIG. 9. In other words, if the advertisement is of great interest to the user, additional means to induce clicking behavior (such as an image of the human finger image or an Animated GIF about clicking) may be added to the published advertisement (421). It should be noted that in the case of the present invention, if the AI determines that the user has already expressed interest, it provides a means (e.g., 900 or 910) to attract the user's attention more. Because the user was already looking at the published advertisement (421), such marketing means (900 or 910) may be much more effective in strengthening the user's interest without offending the user's internet experience.

Finally, in Step S6, the AI ad server and database (100) may report to the advertiser's terminal (300) regarding the results obtained through Steps S1 to S5. Naturally, there should be the user's consent to provide personal information to a third-party company to make a report that might be insightful and meaningful to the advertiser. If there is the user's consent, the client tracking information, AI analysis results, and advertising performance data may be reported to the advertiser. Based on these reports, the advertiser's terminal (300) can secure help in formulating future advertising strategies, such as creating new Internet advertisements or formulating new marketing strategies, and then return to Step S1 and the advertiser's terminal (300) will be able to request Internet advertising again to the AI ad server and database (100). In addition, as will be described later, step S6 includes the step of sending to the advertiser's terminal (300) the result of whether the new advertisement (e.g., 930) with the increased benefits of the promotion was actually able to trigger the user's purchase, as shown in FIG. 10.

FIG. 2 is a drawing representing an exemplary configuration of AI software (200) that can be used for AI gaze analysis according to the one embodiment of the present invention.

The AI software (200) typically has to go through various processes such as (a) problem definition, (b) data acquisition and preparation, (c) model development and training, (d) model evaluation and refinement, (e) deployment of AI in actual products, and (f) execution of machine learning operations. Since these processes are not completely independent of each other but are interlinked, it may be desirable to link an external server and an AI advertising server and database (100) to efficiently assist the AI computing process, rather than limiting the AI analysis according to the present invention to physically only one place. In addition, as already described, according to other embodiments of the present invention, it is also possible to configure at least part of the AI software (200) to be run on a client terminal (400).

Continuing with FIG. 2, the AI software (200) according to one embodiment of the present invention may include a generative AI tool (210). Generative AI tools (210) are responsible for receiving training data input and creating similar text, images, or media based on the patterns and structures of the input training data. In the present invention, for example, it is possible to produce a means (e.g., 910) that can attract more attention to the user as shown in FIG. 9 in various formats such as images, text, and video, and such a generating process can be aided by a generative AI tool 210. In this case, generative AI tools (210) can be especially important for advertisers, because, as mentioned above, a means to attract more attention to users (e.g., 910) is ultimately a means to increase conversion rates, or CVRs. On the other hand, for example, in FIG. 10, which will be discussed later, generative AI tools (210) may be particularly important for advertisers in that the new advertising materials (e.g., 930 in FIG. 10) created by generative AI tools (210) may give an insight about how much benefit would change the user's purchase behavior as the marketing benefit changes in real time.

Further, the present invention comprises a large language model (211, Large Language Model; LLM) as a sub-model. In addition, since recent Internet advertisements are often made in videos created by others, the Multimodal Foundation Model (212, Multimodal Foundation Model; MFM) in generative AI tools (210).

The AI software (200) in FIG. 2 is based on machine learning (ML) tools (220). For example, a large amount of self-camera data stored on a user's smartphone (400) can be used as important machine learning training data for the AI software (200) to analyze the user's gaze. In addition, the accuracy of user gaze analysis can be improved by collecting the user's facial data, head posture data, and gaze data in various situations, such as when the user is wearing glasses or a mask, or when the user's viewing angle is at an angle different from the usual situation.

A machine learning tool (220) according to one embodiment of the present invention may adopt a deep learning model (221) that analyzes a given data by dividing it into multiple layers, and a supervised learning model (222) that implements learning modeling so that the results of the user's gaze analysis can lead to an output value of an interest induction method in the form of a reference number (900 or 910). In other words, it is not a method of driving machine learning by entering the expected value in advance to determine what kind of result is desirable. Of course, it is also possible to adopt an unsupervised learning model (223) that improves the recognition accuracy of the user's gaze by modifying trial and error while imitating the training data by the AI software (200) on the neural network without providing the above training label data for training.

In addition, the AI software (200) according to the one embodiment of the present invention may include NLP tools 230. It is true that the data related to the user's face and eyes is the most important in the eye analysis of the present invention, but it is to be able to filter out the text and background, for example, engraved on the clothes the user is wearing during eye analysis.

The natural language processing tool (230) is a natural language understanding (Natural Language Understanding; NLU) model (231). Natural language generation (Natural Language Generation; NLG) model (232) may be particularly useful in AI analysis (i.e., step S4) and step S5 described above. For reference, since the AI advertising system (500) according to the present invention is not only for a specific country, the translation function of the AI software (200) according to the present invention may be a very important part, although it seems to be independent of facial recognition. For example, if a traveler traveling from Korea to France is browsing a smartphone (400) in front of a specific museum in France, the image or text information about local museum promotions in France reflected in the camera (410) of the smartphone (400) can be used as the target of AI analysis. In a similar vein, for example, if the new advertisement in FIG. 10 (930) contains a foreign language, a natural language processing tool (230) may be useful.

Referring to FIG. 2, the AI software (200) under the present invention must include a computer vision tool (240). The present invention uses a technique for analyzing the user's gaze and estimating the user's interest in Internet advertisements based on the results. Therefore, computer vision tools (240) are essential for user gaze analysis.

First of all, it is desirable for computer vision tools (240) to use an object detection model (241) that extracts only the objects necessary for gaze analysis from images or videos of human eyes, nose, mouth, hair, glasses, hands, and other objects in the background. For example, in an offline store, a user may compare the on-site product price with the online price while looking at the smartphone (400) screen, and in this case, in order to accurately recognize the user's gaze reflected in the smartphone (400) camera (410), it may be necessary not only to recognize the user's face, but also to distinguish objects in the background, not the user.

The Scene Understanding model (242) is also one of the AI models that can be adopted in computer vision tools (240). The scene understanding model (242) performs AI analysis on which objects in an image or video should be treated as more important, and which objects have a certain level of importance or priority over others. From the machine's point of view, the user's face, which is just a set of pixels, can be subdivided into various objects such as eyes, nose, mouth, pupils, iris, and eyelids by applying the scene understanding model (242), and it is possible to calculate which objects should be treated as important for the purpose of gaze analysis.

The Face Detection and Recognition model (243) in FIG. 2 is basically a technology that finds and identifies a person's face in a digital image or video. AI technology used in social media, photo organizers, facial recognition security entry, and even criminal investigations can infer the age of the person being analyzed (for example, the pupil reflex darkens with age), gender, and emotions from facial expressions and appearance. In other words, the user's facial data collected by the camera 410 according to the present invention is the object of analysis of the above facial detection and recognition model (243), which is combined with the results of the user's gaze analysis described below to enable a more sophisticated analysis of the user's interest in advertising materials. For example, AI ad server and database (100) can detect changes in the user's facial expressions after viewing advertisements and provide feedback to advertisers (300) whether they need to make changes to the advertisements.

On the other hand, the eye and gaze tracking model (244) of FIG. 2 is a key AI component in the present invention. The eye and gaze tracking model (244) can be divided into two sub-fields. One is to determine the position of the eyes (“eye localization”), and the other is to find out the direction of the eye's gaze (“gaze estimation”). For reference, in eye analysis using AI, “eye” mainly refers to the pupil (including both dark pupil and bright pupil) and iris (Iris), and in addition to pixel data about the pupil and iris, eye analysis also uses images or video information related to corneal reflection (Iris Reflection), limbus, pupil contour, and eyelid (eyelid). In other words, eye localization focuses on accurately judging the existence and position of the human eye in a given image or video, and the gaze estimation focuses on analyzing the position of the eye in each frame of the image or video and finding out the person's current gaze and the direction of gaze movement in three-dimensional space.

Due to the technical differences mentioned above, it may be difficult to treat eye tracking models and eye tracking models equally in principle. However, from the perspective of eye oculography, it is possible to combine the two models and refer to them as the eye and gaze tracking model (244) as shown in FIG. 2. In the present invention, it is judged that an integrated expression of an eye and eye tracking model (244) is sufficient.

For reference, in the eye tracking stage, AI can also refer to information about the position and posture of a person's head. In addition, even within the area of the eye, the color can vary slightly depending on the surrounding environment, and research is being conducted on the influence of the surrounding environment on the color of the eyes in the image. For this reason, the present invention proposes to comprehensively analyze information such as human faces, facial expressions, body and head postures, glasses (especially necessary for correcting the distortion phenomenon of eye pixel data by thick magnifying glasses, etc.), and the background screen in the camera, rather than simply performing AI analysis on the eyes. As I continue to emphasize, since the present invention determines whether or not a user is interested in an Internet advertisement based on AI gaze analysis, it will be possible to more accurately determine whether the user is interested through various combinations of the models shown in FIG. 2.

It is also easy to understand that the computer vision tool 240 in FIG. 2 includes a motion analysis model (245) in light of the aspects described above. For example, depending on the position of a person's head, the eyelids can sometimes appear straight and sometimes oval in a single image, so defining parameters such as the shape of the eyelids must be a certain shape may cause errors in accurate gaze analysis. The motion analysis model (245) is a technique for finding out what kind of action has been performed in the captured image based on two or more continuous image sequences created by a camera or a high-speed camera that shoots images, and such motion analysis data may be required for precise calculations of the eye and eye tracking model (244).

Finally, computer vision tools (240) are used to analyze text recognition models (246), such as optical character recognition (OCR) model (246) can be included incidentally. If the camera of a smartphone (400) contains a large amount of text in the background of the user video being filmed, it may be able to provide some assistance to AI analysis as an auxiliary means of the aforementioned scene understanding model (242).

Before moving on to FIG. 3, it would be desirable to clarify the difference between the AI software (200) according to the present invention and the so-called “Chat GPT™” that has become very popular recently. As shown in FIG. 2, the AI software (200) for analyzing the user's gaze according to the present invention may include a generative AI tool (210), but this does not mean that the AI advertising technique under the present invention is somewhat unrelated to a system similar to Chat GPT, such as a system in which a user asks the AI something in an AI chat window and Chat GPT provides the result value. In the present invention, the process of the user's thinking about the optimal question to ask the AI to obtain the desired result (that is, refining process) is not included as a component, unlike the Ghat GPT, so the AI gaze analysis technology or the corresponding change of the advertisement exposure method are independent of Chat GPT.

FIG. 3 is a drawing showing the operation mode of an AI software (200) equipped with a computer vision tool (240) according to one embodiment of the present invention.

Referring to FIG. 3, the image or video data taken by the camera (410) of the smartphone (400) is provided as the initial input value of the computer vision tool (240) through step SS1. Image or video data will be entered from Step SS2 to the eye-tracking module (240a) and Step SS4 to the eye-detection module (240d), respectively. In Step SS3, the eye-tracking module (240a) identifies pixel data related to the pupil and iris in an image or image, and collects pixel data related to corneal reflexes, corneal limbus, pupil contour, and eyelids, and executes eye localization actions to accurately determine the presence and position of the human eye in a given image or image. The ocular position information obtained from Step SS3 can be transmitted to the eye-detection module (240d) together with the camera data transmission of Step SS4. The eye-detection module (240d) feeds back the initial (and subsequent) eye position detection results recognized by the eye-detection module (240d) from Step SS5 to the eye-tracking module (240a), allowing for real-time cyclic correction of images or video data continuously input from the camera (410).

On the other hand, the head-posture module (240b) analyzes information about head posture in the image or video of the camera (410) (step SS7), and step SS8 sends the analysis results to the gaze-determining module (240c). The eye-tracking module (240a) also transmits data related to eye position from step SS6 to the gaze-determining module (240c). The gaze-determining module (240c) performs a gaze analysis operation to determine where the user's pupils are facing in three-dimensional space by combining the eye position information received from the eye-tracking module (240a) and the head posture information received from the head-posture module (240b) (step SS10). The final analysis results of the gaze-determining module (240c) and the eye-detection module (240d) (i.e., the gaze coordinates of the gaze-determining module (240c) and the eye position coordinates of the eye-detection module (240d)) are transmitted to the application module (100a) that exists in the AI ad server and database (100), and then the application module (100a) executes step S4 of FIG. 1. In other words, in Step S5, the application module (100a) is responsible for organizing, classifying, and transmitting the results of user gaze analysis to the AI ad server and database (100) just before the AI ad server and database (100) determines and executes the advertisement display plan that can attract more attention to the client terminal (400) users. Furthermore, the application module (100a) determines whether a new advertisement (e.g., reference number 930 in FIG. 10) should be generated based on the analysis results of the AI software (200) on whether the user is staring at an existing advertisement (e.g., reference number 920, FIG. 10). In order to objectively determine whether the user is staring at an existing advertisement (e.g., reference number 920, FIG. 10), it is desirable to establish a mathematical standard such as Table 1 described below.

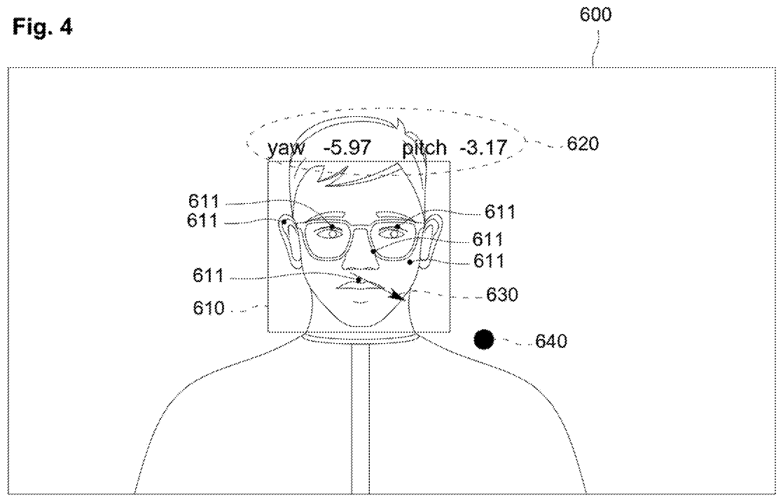

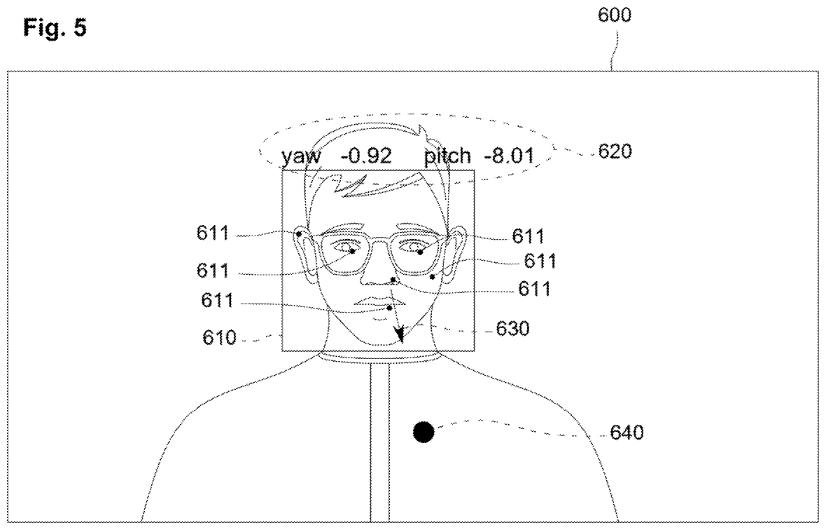

FIG. 4 and FIG. 5 are drawings for illustrating the image data and related gaze data analysis information analyzed in real time by computer vision AI software according to one embodiment of the present invention. In FIG. 4 and FIG. 5, the reference number 600 is the camera video screen (600) including the user who is being recognized in real time by the camera (410) of the smartphone (400) for example. The application module (100a) of FIG. 3 will utilize the gaze analysis results as shown in FIG. 4 and FIG. 5.

Referring to FIG. 4 and FIG. 5 together, the camera image screen (600) virtually overlaps the area (610) that recognizes the user's face. In this virtual face recognition area (610), imaginary points called key marks (611) are generated throughout the face image as shown in FIGS. 4 and 5, and these key marks (611) also move in real time according to the user's face or eye movements. After that, using the pre-set calculation program, the pitch (the angle at which the head is nodded up and down) and the yaw (also known as the so-called purlin motion, the angle when turning the head from side to side) are calculated. For reference, pitch is measured from −90 degrees to +90 degrees based on an imaginary horizontal line that runs through both ears, and yaw can be measured from −180 degrees to +180 degrees based on an imaginary vertical line that penetrates the top of the head vertically when the head is upright. These pitch and yaw values also fluctuate in real time with human movement and can be overlaid on the camera image (600) in the same form as the reference number 620, as shown in FIGS. 4 and 5.

In FIG. 4 and FIG. 5, it can be seen that the virtual overlapping arrow (630) and the point (640), which are also displayed virtually, change as the pitch and yaw values change, with the arrow (630) representing the direction of the user's gaze and the dot (640) representing the point within the user's smart device (400). Therefore, if the user does not look at the screen of the smartphone (400) at all (420) and turns his head in a different direction, the point (640) that the user is looking at may not appear.

Next, FIG. 6 is an example of a screen (700) synthesized with a specific website in the form of a map of the user's gaze analyzed by AI according to one embodiment of the present invention and in the form of a map of the scanpath (movement path of the gaze) according to the leaping eye movement (instantaneous movement of the eyeball). In other words, FIG. 4 and FIG. 5 show the image (600) projected by the camera, while FIG. 6 can be seen as a gaze map that tracks how the user moves on the screen of a smartphone (400, e.g., see FIG. 8) based on the results of gaze analysis such as FIG. 4 and FIG. 5. In short, the screen (700) in FIG. 6 represents the first example of a gaze map.

Referring to FIG. 6, it can be seen that the area where the Internet advertisement (710) is located has not been scanned by the user at all. In other words, according to the gaze map (600) in FIG. 6, the user's eyes start from P1 and repeat the leap eye movement, looking only at P2, P3, . . . , and P13 points, and no longer looking at this web page. In this case, it is premised that the marketing method such as forcibly drawing the user's interest in the Internet advertisement (710), such as forcibly opening a pop-up window, is not of great significance in the present invention. This is because Internet advertisements (710) that do not attract users' attention may be recognized as cyber pollution.

FIG. 7 is an example drawing of a heat map (800) made by analyzing the user's gaze by AI according to the embodiment of the present invention and the period during which the focus of the eye is fixed (Fixation, the moment when the eyeball is relatively fixed). The reason for the expression “heat” is that if the user has been staring at it for a long time, it will express a stronger color like a thermal imaging camera.

In short, the screen (800) in FIG. 7 can be seen as representing the second example of a gaze map created to improve advertising efficiency according to the present invention. In the case of FIG. 7, the darker the concentration (i.e., the heat index), the more the user continued to stare and for longer. For example, if we assume that the relatively high heat index in FIG. 7 is the H1 and H2 parts, we can see that the H2 part overlaps with the Internet advertisement (810). In other words, it can be said that the Internet advertisements (810) in FIG. 7 have received user attention, and the AI ad server and database (100) in Step S4 in FIG. 1 will prepare to move to Step S5.

Of course, for example, in FIG. 7, the threshold for determining whether or not users are interested can be used as the threshold for determining whether or not the Internet advertisement (810) has acquired a certain level of gaze concentration (or heat index). If in the example of FIG. 6, whether or not to recognize the user's interest as being interested in an Internet advertisement (710) just because it is on the path of the scanpath may be a matter of system settings rather than the existence of an absolute interest criterion.

The following table represents the variables related to eye measurement that can be used by the AI software 200, including the user's eye and eye-tracking model 244 according to the present invention. Now, these variables and data can be called as “gaze information.” Rather than all of these variables being the criterion for determining whether the advertisement has attracted the user's attention in the present invention, it will be possible to set a threshold value with one or more combinations

TABLE 1
Example of gaze information

| Variables related to eye tracking | Units of Variables |
|---|---|
| Number of leap eye movements (Saccade) | N (N: natural number) |
| Average size of leap eye movement | Pixel |
| Length of scanpath | Pixel |
| Duration of scanpath | Msec (1/1000 sec) |
| Convex Hull | Pixel² (the size of the area created by |
| | connecting the outermost vertices of the |
| | scanpath) |
| Spatial Density | % (ratio between the total area of the |
| | screen and the area where the eye was |
| | fixed during the scanpath) |
| Fixation period | Msec (1/1000 sec) |
| Number of Focus Fixes | N (N: natural number) |
| Pitch and Yaw | Degree |

For example, in Table 1 above, for example, Internet advertisements (e.g., Dress Sale! Shop Here! If the AI ad server or the main server of the AI ad server and database (100) determines whether the advertisement overlaps with the advertisement display area (e.g., reference number 421 in FIG. 8 below) on which the advertisement is posted, the criteria for determining (a) whether the measured duration of fixation exceeds a predetermined threshold, (b) whether the advertising display area exists on the scanpath; (c) the presence or absence of the display area in the Convex Hull created by the scanpath may be set to objectively judge the user's interest in the published internet advertisement. For reference, the convex hull refers to the size of the area created by connecting the outermost vertices of the scanpath, and in the case of FIG. 6, it will be a polygon connected in the order of P1, P13, P4, P5, P8, P2, and P3. In the example shown in FIG. 6, “Shop Now! For Sale!” advertisement (710) can be seen as not receiving user attention even according to criterion (c) among the above three examples. When the AI ad server and database (100) tracks whether the user's gaze overlaps with the advertisement display area (422, FIG. 10) where the Internet advertisement “10% Coupon” (920) exemplified in FIG. 10 is posted, one or more of the many criteria described in Table 1 may apply.

FIG. 8 shows an example of modifying the display size of the internet advertisement in which a user is currently interested in, after completing the AI analysis of the user's gaze according to one embodiment of the present invention. As described in FIG. 1, in Step S3, the client tracking information and the image or video data collected by the camera (410) are sent to the AI ad server and database (100) for storage. In the case of FIG. 8, in the advertisement display area (421), there is an advertisement “Dress Sale! Shop Here!” banner is being displayed, and the analysis of the user's gaze on the display screen (420) of the smartphone (400) is preferably done in real time on the AI ad server and database (100) side.

As a result of AI analysis, for example, if there is an AI judgment that the advertisement satisfies the threshold of the existence of user interest based on the variables presented in Table 1, the process may move on to step S5, and the AI ad server and database (100) determines the method of ad exposure or advertisement display mode that can attract more attention to the user of the client terminal (400) based on the results of the user gaze analysis conducted in step S4, and preferably implement the plan in real time. For example, in FIG. 8, if a user is using “Dress Sale! Shop Here!” banner for more than a certain amount of time, the AI ad server and database (100) will display the “Dress Sale! Shop Here!” banner ad is immediately sent to increase the size of the advertisement to attract more attention from users. In this case, the first display mode would be an original-size banner display (421) and the second display mode would be a larger banner display (900).

FIG. 9 is a drawing showing another example of changing the way the user is exposed to an advertisement that the user is interested in after completing an AI analysis of the user's gaze according to one embodiment of the present invention. The difference from FIG. 8 is that the “Dress Sale! Shop Here!” banner ad display now includes a finger icon (910) meaning “Click here”, and the AI ad server and database (100) runs Step S5. On the other hand, the database (110) commonly shown in FIG. 8 and FIG. 9 plays the role of classifying and storing image or video data collected by the camera (410) from the AI ad server and database (100), and the billing part (120) is a server for cost settlement, for example, and according to the present invention, if a user click is successfully made through a change in the mode of advertising exposure (that is, an addition of icon 910 in case of FIG. 9), the details about such mode change and change of customer behavior are aggregated, and statistics may be provided to the advertiser (300). Here, it may be possible to set additional advertising costs for successful marketing because the AI system increased the likelihood of successful user clicking on the advertisement based on the complex eye and gaze analysis.

FIG. 10 is an illustration showing an example of upgrading the user's benefit offered in the original internet advertisement to some higher level in real time based on the results of AI's gaze analysis according to one embodiment of the present invention. As shown in FIG. 10, the user is currently staring at the “10% Coupon” advertisement (920). For reference, this conclusion is drawn when the AI analysis that met the predetermined judgment criteria exemplified in Table 1 was completed in real time after Step S3.

After that, the AI ad server and database (100) will send new advertisements (930) in real time and display them on the screen (420) of the client terminal (400), for example, using the AI model related to language processing mentioned above, and say, “Thank you for looking at this coupon now! As a token of appreciation, we will provide you with a 20% discount coupon for 1 minute” to help users understand why the coupon's benefit level was suddenly increased. It should be noted that the 10% coupon advertisement (920) was instantly changed to the 20% coupon advertisement (930) when the customer looked at the 10% coupon advertisement (920), for example, with a fixation of duration that is more than 3 seconds. Any variable in Table 1 may be a criteria for determining whether to change the 10% coupon (920) to 20% (or even more discount) coupon (930) instantly for a user who showed enough interest in the published advertisement. The present invention expects that such real-time change of marketing benefit based on gaze analysis would greatly improve the CVR.

For reference, in FIG. 10, the creation of a new advertisement (930) can be handled by a generative AI tool (210) as mentioned above, or the advertisement sent and stored from the advertiser's terminal (300) can be used as a new advertisement (930). In either case, the increase in the benefits of advertising materials may be a sensitive issue related to advertising costs and margins, so prior approval from the advertiser (300) will be required.

If a customer behavior's change (that is, actual purchase of the advertised product) occurs when a new advertisement is presented (930), it will be possible to bill and transmit additional advertising costs as a success fee along with client tracking information in step S6 of FIG. 1 mentioned above, and the billing server (120) will be responsible for the work related to these costs.

So far, referring to FIGS. 1 to 10, we have examined in detail the advertising method, system, and related AI program based on AI gaze analysis according to the present invention. As mentioned above, the present invention proposes to use an AI analysis tool called complex computer vision (200, 240) which can process images, videos, or both, in particular, to analyze the interests of Internet users. As previously premised, the present invention focuses on Internet advertising (e.g., 710, 810) targeting users of smart devices (400) equipped with cameras (410). In other words, the present invention analyzes which part of the screen (420) that the user is currently viewing by using a camera mounted on a smart device, and precisely confirms the user's interest through this, so that the advertiser (300) can accept that the user's interest measurement method according to the present invention is reasonable. In particular, it is worth noting that by objectifying and quantifying the criteria for judging the existence of user interest based on the results of gaze analysis and introducing thresholds, the reliability of advertising efficiency can be highly recognized by advertiser terminals (300), and the advertising exposure method has been made more accessible to consumer terminals (400) only for useful information.

Furthermore, the present invention is configured to dynamically change the exposure method of Internet advertisements based on the user's gaze analyzed by AI, for example, as in FIG. 8 or FIG. 9, and to use the Gaze Map shown in FIG. 6 or FIG. 7 as a criterion for judging such dynamic changes, so that it is possible to analyze whether the space to load the advertisement is ideally placed on the screen of a smartphone in light of the gaze map such as FIG. 6 or FIG. 7. This analysis will be included in the feedback given to advertisers (300) in step S6, and it is expected that it will provide advertisers (300) with better insights for follow-up ads.

In addition, if the AI gaze analysis according to the present invention is performed in real time on an AI ad server and database (100), it is expected that the display method of the advertisement can be changed in real time according to the situation, which is expected to maximize the efficiency of the advertisement. In particular, since the present invention judges the user's interest based on the user's ever-changing web surfing and the corresponding movement of the pupil, it may be more desirable to configure a series of actions from steps S3 to S5 in FIG. 1 or the entire process shown in FIG. 1 to be performed in real time.

As above, the present invention filters out advertisements that do not attract the attention of Internet users and advertisements that attract the attention of Internet users by AI, and thereby enables dynamic advertising exposure that can increase the advertising effect for advertisements that can be useful Internet information to users, thereby improving the efficiency of advertising cost execution from the advertiser's point of view, and the advertisements presented according to the present invention can be recognized as useful information from the user's point of view.

On the other hand, in the case of the present invention, for example, not only the exposure method of Internet advertisements, but also the promotional benefits of the advertisements themselves are adjusted in real time as exemplified in FIG. 10, so it is expected that step S6 can provide marketing insights to advertisers (300) that cannot be provided by other existing advertising techniques. In other words, if it is judged that the 20% discount rate will reduce the margin in the example of FIG. 10 but will bring a better sales increase effect, it may be possible to go back to step S1 and designate the new advertisement (930) as the requested advertisement instead of the existing advertisement (920).

In addition, a new advertisement (930) with an increased promotional benefit under the present invention may be provided to all consumers who take the existing advertisement (920), or it may be provided to only a subset of consumers on a trial basis according to the constraints set by the advertiser. Because the purpose of the present invention is to provide the advertiser 300 with the most reasonable marketing insights, the process of an AI ad server and database (100) to determine whether or not a new advertisement can be sent can be performed before the execution of step S5, although it is not shown in FIG. 10.

As above, the present invention not only changes the method of displaying advertisements, but also proposes a method of filtering out advertisements that do not attract the attention of Internet users and advertisements that attract the attention of Internet users by AI, and thereby increasing advertising benefits for advertisements that can be useful Internet information to users, and actively inducing behavioral conversion to clicks or purchases. This will allow advertisers to assess how much promotional benefits they need to provide to make a purchase.

The drawings and detailed descriptions of the present invention are not intended to limit the scope of the rights of the present invention. A person with ordinary knowledge in the industrial field to which the present invention belongs may refer to the attached drawings and detailed descriptions to make various design changes within the scope of the technical idea of the present invention. For example, the attached drawings of the present invention show that the AI software (200) performs computational operations within the AI ad server and database (100), but as mentioned above, it is possible for all or part of the AI software (200) to be installed on the client terminal (400) with the consent of the customer or to be supported by an external AI server (200).

What is claimed is:

1. A computer-implemented method for providing an internet advertisement to a user terminal equipped with a camera by using an advertising server, comprising:
receiving the internet advertisement from an advertiser terminal;
transmitting the received internet advertisement to the user terminal so that the internet advertisement may be shown with a first display mode on an advertisement display area in a display screen of the user terminal;
collecting an image or video data including a user face, through the user terminal and the camera, to be analyzed by an AI analysis tool installed on the user terminal or the advertising server;
analyzing a gaze information from the collected image or video data by the AI analysis tool to determine whether a user's gazing area is at least partially overlapped with the advertisement display area; and
adjusting the first display mode to a second display mode through the user terminal if the gazing area is at least partially overlapped with the advertisement display area.

2. The method of claim 1, wherein the adjusting includes increasing a display size of the internet advertisement in the advertisement display area.

3. The method of claim 1, wherein the AI analysis tool includes a complex computer vision AI analysis tool that may process images, videos, or both, and
a criteria for determining whether the gazing area is at least partially overlapped with the advertisement display area may be at least any one of (a) whether a duration of fixation included in the gaze information exceeds a predetermined threshold on the advertisement display area, (b) whether a scanpath included in the gaze information exists at least partially on the advertisement display area, or (c) a Convex Hull based on the scanpath overlaps at least partially with the advertisement display area.

4. The method of claim 1, further comprising:
creating a user's gaze map on the display screen regarding the gaze information by the AI analysis tool when determining whether the gazing area is at least partially overlapped with the advertisement display area.

5. An advertising system for providing an internet advertisement to a user terminal equipped with a camera, comprising:
a main server that receives the internet advertisement from an advertiser terminal, and transmits the received internet advertisement to the user terminal so as to cause the internet advertisement to be published and displayed with a first display mode on an advertising display area in a display screen of the user terminal; and
a database that collects, classifies, and stores an image or video data including a user face through the user terminal and the camera, to be analyzed by an AI analysis tool installed on the main server,
wherein the AI analysis tool analyzes a gaze information from the stored image or video data to determine whether a user's gazing area is at least partially overlapped with the advertisement display area; and
wherein the main server causes the first display mode to be adjusted to a second display mode at the user terminal if the gazing area is at least partially overlapped with the advertisement display area.

6. A computer-implemented method for providing an internet advertisement to a user terminal equipped with a camera by using an advertising server, comprising:
receiving the internet advertisement from an advertiser terminal;
transmitting the received internet advertisement to the user terminal so that the internet advertisement may be published with a first display mode on an advertisement display area in a display screen of the user terminal;
collecting an image or video data including a user face, through the user terminal and the camera, to be analyzed by an AI analysis tool installed on the user terminal or the advertising server;
analyzing a gaze information from the collected image or video data by the AI analysis tool to judge whether the published internet advertisement draws a user attention based on a predetermined criteria; and
adjusting a marketing benefit originally included in the published internet advertisement to a higher level of benefit if it is judged that the published internet advertisement draws a user attention.

7. The method of claim 6, wherein the predetermined criteria may be at least any one of (a) whether a duration of fixation included in the gaze information exceeds a predetermined threshold on the advertisement display area, (b) whether a scanpath included in the gaze information exists at least partially on the advertisement display area, or (c) a Convex Hull based on the scanpath overlaps at least partially with the advertisement display area.
